(19) United States
(12) Patent Application Publication
(10) Pub. No.: US 2005/0110909 A1
(43) Pub. Date: May 26, 2005

(54) Digital remote control device

(76) Inventors: Declan M. Staunton, Dublin (IL); Eduard W. Salomons, Dublin (IL)

Correspondence Address: PHILIPS INTELLECTUAL PROPERTY & STANDARDS, P.O. BOX 3001, BRIARCLIFF MANOR, NY, 10510, US

(21) Appl. No.: 10/509,479

(22) PCT Filed: Mar. 21, 2003
(86) PCT No.: PCT/IB03/01194

(30) Foreign Application Priority Data
Apr. 4, 2002 (GB) 0207791.5

(51) Int. Cl. H04N 5/44

(52) U.S. Cl. 348/734; 725/81

(57) ABSTRACT

A remote control device 4 is for use with a television receiving apparatus 1. The television receiving apparatus 1 comprises a system controller 2, a receiver for receiving broadcast video data and supplemental textual data and a TV display 3 for displaying the data. The remote control device 4 is operable to communicate with the system controller 2 of the television receiving apparatus 1 and has it's own display 8 and user-operable control. The remote control device 4 comprises means responsive to the user operable control for requesting and downloading video and/or supplemental textual data received by the television receiving apparatus 1. This video and/or supplemental textual data is not currently displayed on the TV display, and is viewed by the user on the display 8 of the remote control device 4.

This invention relates to a remote control for a multimedia TV receiver. In particular the invention relates to a remote control with a display and two-way communication with a multimedia TV receiver that is configured to enable a variety of novel, interactive applications.

GB-A-2343073 describes a remote control with a display which is configured for the display of electronic programme guides (EPG), teletext and internet content remotely from a TV set. The document further describes a facility for the instant replay of part of a televised program being watched by a user.

WO 00/59212 describes a remote control also capable of providing on a display remote from the TV display, EPG and other information and data. In addition, the remote control described in WO 00/59212 is provided with a soft graphical user interface (GUI) and speech recognition facility whereby the user can, for example request information from the EPG related to a specific topic (such as sport, movies or a named TV show).

The described prior art remote controllers are limited in function in that they provide only information or data specifically requested by the user. Also, video images, which are displayable remotely using these prior art devices, are restricted by the channel selection being viewed on the TV at the time of use of the remote control.

The present invention aims to further extend the user applications for a remote control with a visual display.

In accordance with a first aspect the present invention provides a remote control device for use with a television receiving apparatus, the television receiving apparatus comprising; a system controller, a receiver for receiving broadcast video data and supplemental textual data and a TV display for displaying the data, the remote control being operable to communicate with the system controller of the television receiving apparatus and having its own display and user-operable control, wherein, the remote control device comprises means responsive to the user operable-control for requesting and downloading video and/or supplemental textual data received by the television receiving apparatus and not currently displayed on the TV display, to be viewed by the user on the display of the remote control device.

The invention is conveniently implemented where the television receiving apparatus system controller comprises two tuners, a first of which is operable to find data and information for display on the TV display and a second which is operable to find data and information for display on the display of the remote control device.

In another aspect, the invention provides a television receiving apparatus comprising a receiver for receiving broadcast video data and supplemental textual data, a TV display for displaying the data and a system controller, the system controller comprising a plurality of tuners, at least one tuner being controllable by means of a user-operable control associated with a remote control device in accordance with the first aspect, to display data on the display of the remote control device.

In a further aspect the invention provides a television receiving apparatus comprising a receiver for receiving broadcast video data and supplemental textual data in a plurality of data streams, a TV display for displaying data and a system controller, the system controller having means for receiving and processing a request from an alternative display device to display data associated with a data stream, other than that (or those) displayed on the TV display, on the alternative display device.

In another aspect the invention provides a method for displaying images and/or information associated with a data stream received by a television receiving apparatus on a display device remote from the television receiving apparatus comprising; in response to a request, locating a data stream having associated therewith the requested images and/or information; extracting the located data stream; defining the extracted data stream in a form mutually comprehensible to the television receiving apparatus and the remote display device; transmitting the defined data stream to the remote display device; and, rendering the images and/or information associated with the defined data stream on a display screen of remote display device.

In yet another aspect, the invention provides A method for providing interactive participation in a TV programme comprising; in a first data stream, broadcasting video of the programme to be displayed on a first display apparatus associated with a television receiving apparatus; in a second data stream providing information relating to the content of the first data stream to be displayed on a second display apparatus, which second display apparatus is provided with a user interface; and, requesting a user response to the information contained in the second data stream.

The invention permits a user to view on the remote control device images other than the one being watched on the main TV display. This allows the user to follow a program on another channel (for example, to see if an advertisement break has finished, or a news story of interest has come up) without interfering with the viewing of the programme currently on the main TV display. Alternatively, the user may view a teletext page associated with a channel other than that currently displayed on the TV display, or may access internet web sites or send and receive e-mails all without disrupting viewing on the main TV display. Conveniently, the invention may be enabled by means of an all-software decode running on the central processor (CPU) of the set top box (STB) or other system controller of an interactive TV receiver. This allows reduced (but satisfactory) resolution previews to be displayed on the remote display thereby allowing its implementation via relatively simple STB technology with almost zero additional cost to the manufacturer.

Desirably, the remote control device is configured to display requested data whether or not the TV display is active. When the TV display is active, the remote control device will conveniently display images from a TV channel other than that being viewed on the TV display. In addition or in the alternative, the remote control may be configured to request, receive and display images recently displayed on the TV display, such as play back of a previous scene in a programme currently being viewed on the TV display. This feature may be enabled by interaction between the user operable control and a memory in the system controller or by means of a local memory in the remote control device.

The user operable control may be provided in any convenient form including, but not strictly limited to; a keyboard (optionally incorporating a mouse, tracker ball or similar feature to assist in selecting from on screen menu displays); touch screen technology and/or speech recognition.

The remote control device may communicate with the system controller of the TV receiving apparatus by any suitable means. Desirably, communication is via a cordless connection such as (but not strictly limited to) infrared.

Desirably, the remote control device is configured to interact with other audio/visual apparatus such as a DVD player, VCR or games console. In such embodiments, the remote control is provided with means responsive to the user operable control for requesting, receiving and displaying data or information from the alternative audio/visual device other than is currently being displayed on the TV display. Such features permit a user, for example, to view a programme being recorded on a VCR whilst an alternative programme is viewed on the TV display. Alternatively, the user may remotely view a TV programme currently being broadcast, whilst a movie recorded on a DVD is being played on the TV display.

It is known for digital TV broadcasts to comprise both video data and textual information which may comprise separate data streams. The data streams may be transmitted in tandem in a single carrier signal. Such arrangements can be used to provide interactive data such as the positions of contenders in a race, newsflashes, or the latest score in a sports match. It is envisaged that such technology could be used to provide an interactive medium via the display of the remote control device of the invention. For example, the user operable control may be configured to download quiz questions to the remote control display and to upload answers to these questions. Again, the user may have this interactive experience without interfering with the enjoyment of a TV programme by other viewers of the main TV display.

In the case of a suitably live broadcast sporting event, position data of players/participants may transmitted by a broadcaster in tandem with a live broadcast (for example, by image processing on a video feed from a fixed camera). In addition, a graphic representation of the players may be superimposed on a representation of the course/pitch/track at which the live sporting event is occurring and downloaded for display on the screen of the remote control device whilst the live action is broadcast on the main TV display. A continuously updated field displaying event statistics may augment the graphic representation. By interaction with the remote control device by means of the user-operable display, the user may choose control options for the display of the event on the TV display. For example, the user may select camera angles, audio feed locations and the like simply by indicating desired locations on the graphic representation. The user selections may then be uploaded to the broadcaster via the system controller of the TV receiving apparatus and the camera view/audio feed may be transmitted to the remote and/or TV display in accordance with the user's requirement.

In addition, or in an alternative, where the live action video and graphic representation are stored in conjunction, the graphic representation (stepped through at high speed) would allow a user to quickly identify interesting passages of play and then mark them to create a highlights package from the recorded video.

In a further development of the aforementioned interactive applications, it is envisaged a broadcasting company could encourage channel loyalty through a “loyalty points” scheme. The “points” are provided in the form of electronic credits. Such schemes are well known in the retail industry where purchasers are awarded points electronically via a loyalty card in return for spending a certain amount of money in a store. In the proposed scheme of the invention, broadcasters send points (carried in an electromagnetic signal) to a TV receiver embedded in a video broadcast. The remote control device is provided with a user operable control for requesting and downloading these loyalty points and a memory for storing the points. In further broadcasts, the broadcaster may send interactive information directly to the remote control device via the same route as the points. Such interactive information may provide the user with opportunities to spend loyalty points or to acquire additional points, for example by betting points on the outcome of a future event posed by the broadcast interactive information.

Points accrued may be used to purchase items or services offered for sale by the originating broadcaster. For example, points may be traded for viewing of a pay-per-view presentation. Alternatively, character merchandise associated with a flagship TV show broadcast by the broadcaster may be purchased with the loyalty points in place of actual currency. In a further alternative, telephone calls or Internet access made utilising the same service provider as supplies the interactive TV data may be paid using accrued points. Points may be awarded by the broadcaster as a reward for certain behaviours, for example watching advertisements or buying goods or services.

A particular embodiment provides a gaming/gambling arrangement based on the “loyalty points” system, and having a number of particular features: points may be given freely by a broadcaster to encourage the user to gamble with them.

The gaming/gambling activity is in the form of questions appearing on the remote display, relating to a TV programme which the user is currently watching on the main TV display. The remote control device is suitably configured such that the broadcaster can “wake up” the device from a dormant state to present questions to the user; and user response (or lack of it) to gaming questions may be used to build up a user profile. User profiles may subsequently be used by the broadcaster for selective advertising and marketing purposes. For example, where a user is recognised to respond to questions related to sporting presentations, the broadcaster may target the user with advertisements directed to sporting magazines, sports clothes and future, pay-per-view sporting presentations to be broadcast by the broadcaster.

Other possibilities will no doubt occur to the skilled artisan without departing from the true scope of the invention.

In another aspect, the remote control device of the invention may be used in association with digital recording apparatus, for example a video camera/recorder. Scenes recorded by the camera/recorder could be remotely downloaded and edited using the remote display and an appropriately configured user interface. The complete edited version could then be uploaded back to the camera and recorded on a data carrier for reproduction and personal use.

In a further interactive application, a broadcaster may have the facility to “wake” the remote control device from a dormant state, for example by downloading an activation code to the device or the system controller. Once the device has been awakened, the broadcaster may selectively send data and information to the remote control device for display. Information may be provided, for example, in the form of downloads of virtual leaflets containing advertising data related to material that the user is currently viewing on the TV display. Where the programme being viewed is a commercial, the data may comprise background information or details of other items in a similar product range. If the user chooses to ignore the downloaded leaflet, it is removed automatically from the remote control device after a defined period, however, if the user acknowledges receipt of the leaflet within the defined period, by interaction with the remote control device, details on the subject matter of the leaflet and the nature of the user's response is passed back to the broadcaster who may use the data to build up a personal profile of the viewer. The profile may be used to selectively target individuals with advertisements for goods or services in which they have historically shown an interest. Such advertising may include the promotion of TV broadcasts on other channels (provided by the same broadcaster) which may be of interest to the user. Leaflets may be sent repeatedly and, where the local system permits, they may be locally cached to avoid the download of such large volumes of data.

Embodiments of the invention and various aspects thereof will now be described. For the purposes of this description, the following terms are to be interpreted as defined.

“Broadband” A transmission medium capable of supporting a wide range of frequencies. In the context of the described invention, this refers to a high-speed (typically 512 kbit/s but up to 40 Mbit/s is possible) Internet connection via cable, DSL, satelite or wireless local loop.

“Gateway” A device that contains a broadband modem, a wireless interface and the associated software to make it an intelligent hub. This may be a set top box (STB), a personal computer (PC) or a stand-alone device.

The following acronyms are believed to be commonly used and understood in the technical field of the invention:

| | |
|---|---|
| ADSL | Asymmetric Digital Subscriber Line |
| DCT | Discrete Cosine Transformation |
| DSL | Digital Subscriber Line |
| DVB | Digital Video Broadcast |
| EPG | Electronic Program Guide |
| FLTK | Fast Light Tool Kit |
| GUI | Graphical User Interface |
| IDCT | Inverse Discrete Cosine Transformation |
| MPEG | Motion Picture Experts Group |
| PDA | Personal Digital Assistant |
| PES | Packetised Elementary Stream |
| POTS | Plain Old Telephone System |
| PSI | Program Specific Information |
| SI | Service Information |
| STB | Set-Top Box |
| VLC | Variable Length Coding |
| XML | Extensible Mark-up Language |

Desirably, the invention is in the form of a communicating portable touch screen display device that allows information normally displayed on the TV screen to be displayed ‘off-screen’ and on the display of the remote, touch screen device. Information may be displayed on the device that is not currently displayed on the TV screen, for example a preview image of another channel or a web page associated with a program being watched. This remote display capability allows a user to find out whatever information he/she likes, such as browsing EPG listings or viewing teletext pages on whatever channel, without disturbing the viewing of persons watching the main TV display. Also, when appropriately configured, the device enables the user to experience a wide range of interactive activities.

The content displayed by the remote control device of the invention is accessed through a gateway device such as a STB, and the device has no direct external network connection of its own. It is envisaged that a plurality of such devices may be used simultaneously, yet independently, in relation to a single TV receiver. For example, each member in a family may have their own personal device. In an alternative, a single device may be equipped with a memory facility whereby a plurality of individual user set ups may be stored and selected by individual users.

Whilst the description of the invention focuses on the device as a TV companion, it should be appreciated that the device has potential application as a universal front end for digital consumer devices such as PVRs, DVDs and MP3 jukeboxes. As these digital consumer devices offer more and more functionality, their user interfaces will become increasingly complex and the device of the invention is a highly appropriate platform to present such user interfaces.

There are two principal features of the device; firstly, the ability to mine information in the gateway device, and secondly, the facility to display images or data on the remote display which relate to different transmissions than that or those displayed on the main TV display.

For the purposes of exemplification, an embodiment of the invention will now be further described with reference to the Figures in which:

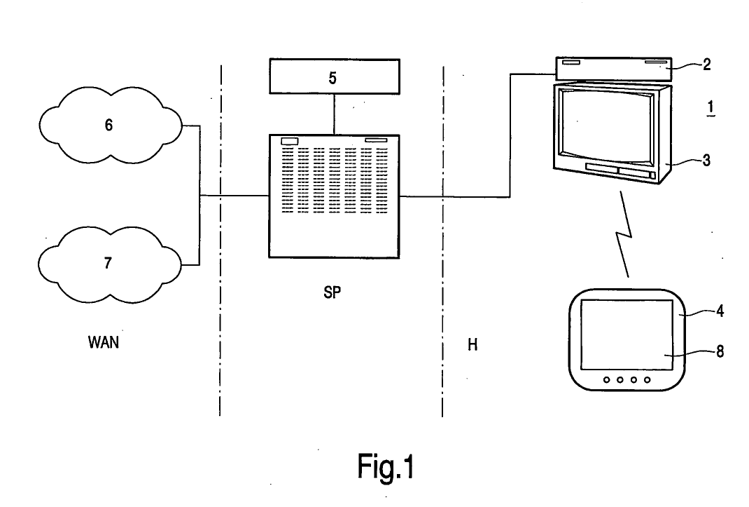

FIG. 1 illustrates the system architecture for an embodiment of a remote display device in accordance with the invention, and

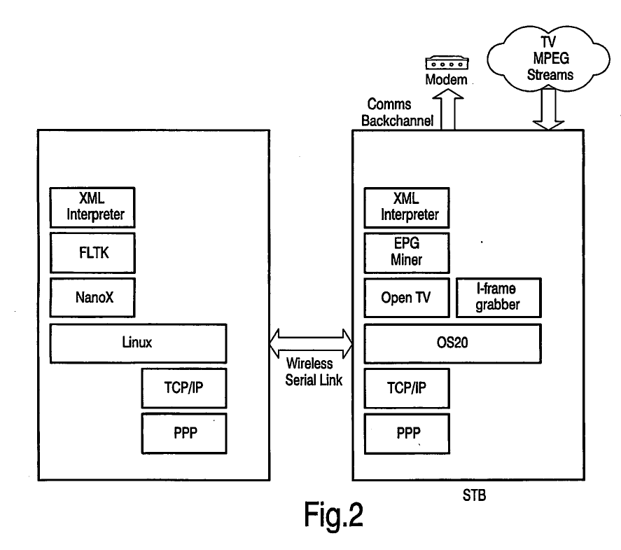

FIG. 2 illustrates the software architecture for an embodiment of a remote display device in accordance with the invention.

FIG. 1 illustrates how content arrives at the remote control device when it is used as a digital TV companion device:

In FIG. 1, a television receiving apparatus 1 is situated in a user's home environment, H. The television receiving apparatus 1 comprises a system controller embodied in a STB 2, and a display, 3. In wireless communication with the apparatus 1 and also in the home environment H is a remote control device 4 as previously described. In a location remote from H, is located the service provider (for example a TV broadcaster) SP, who transmits his own generated content 5 to receiving apparatus 1 in environment H. In addition, service provider SP may also receive, for example, Internet data 6 and content from partner websites 7. The content 6 and 7 can be requested by the television receiving apparatus 1 and transmitted via the service provider SP to the STB 2. As previously described, the remote control device 4 can in turn instruct the STB 2 to request certain content 5, 6, 7 from the service provider SP for display on the display 8 of the remote control device 4.

As shown in the Figure, the link between the service provider SP and the home (or location of the user) H may be any of a satellite, cable, terrestrial broadcast or a telecommunications operator or any other conduit for providing digital TV data. The link is composed of several multiplexes, each of which may carry several video, audio and/or data streams. The skilled addressee will be aware of various methods by which the various streams are multiplexed together as these have been previously described in relation to DVB technology. Several different types of data streams are specified, most notably SI (such as teletext EPG or Internet) and PSI (the video/audio broadcast).

As is also known, certain DVB specifications allow any type of digital information to be transmitted as a private data stream. This data stream may be sent to all receivers, individual receivers or selected groups of receivers and by means of suitable software, the device of the invention can be configured to receive this data independently of the data for display on the TV screen. The WAN connection shown in FIG. 1 is optional, it allows downstream internet data to be transmitted to the device of the invention (the upstream connection is not shown in the Figure, but could, for example, be a POTS or ADSL modem, a cable modem or even a satellite back channel). This arrangement facilitates accessing of both Internet images and TV video broadcasts simultaneously (an activity sometimes referred to as “telewebbing”). Enhanced service (EPG, teletext and the like) delivery is also made possible by this arrangement.

The following describes the method by which information is caught and displayed by the device of the invention.

The display of information on an external device involves a number of stages. The information must first be discovered, then extracted, rendered, transmitted and displayed.

Discovery: When an item of information (for example, an EPG description or an I-frame for a preview image) is requested, the first step is to determine where that information resides. It may be part of an already existing (for example in the STB memory) SI table or it may exist in a different transport stream than the one currently being examined. The discovery phase resolves the location of the item of information being requested.

Extraction: Once the location of the information item has been determined the appropriate information is extracted. The mechanism for extraction will depend on the relevant location. If the item was not available in either the STB memory or the data stream for the channel currently selected for the TV display, then the tuner is instructed to change to the correct frequency (as determined during the discovery phase) for receiving the requested information. The PID and section filters may be configured to build a table that may be examined for the requested information item.

Rendering: With traditional on-screen display of information the rendering phase would consist of drawing the appropriate images on the graphics planes which are superimposed on the TV picture. The inventive device provides for the rendering of images on a display other than the TV screen (i.e. the remote display). The rendering stage therefore, consists of describing the item of information in a form mutually comprehensible to both the gateway device and the remote control device of the invention. In the described embodiment, this is achieved using XML and the appropriate DTD/schema.

Transmission: The XML description of the requested information is transmitted wirelessly to the remote device. This can be achieved by using any number of existing wireless protocols known in the technical field of the invention. For example, Bluetooth, IEEE 802.11 or HomeRF.

Display: Once the XML description of the requested information item has been successfully received it is rendered on the display of the remote control device.

The following describes the functionality of an embodiment of the invention for some user applications. Examples of suitable hardware and software configurations for an embodiment of the invention are now outlined.

Two suitable platforms are the Intel StrongARM SA111x reference board and the Compaq iPAQ H3630 PDA. The iPAQ device features very similar hardware (in particular, the same CPU) to the StrongARM reference board and provides a subset of the StrongARM functionality in a more compact form factor.

In the embodiment described, the STB is a low-end box based on the SGS-Thomson STi5512 chip. This chip features a 60 MHZ ST20 32-bit processor that provides sufficient processing power to control the STB and run all native applications. There is a limited amount of processing power (the exact amount depends on what else needs to be done simultaneously) available to run other applications such as the I-frame grabber or EPG miner incorporated in the present invention. More advanced STBs feature higher performance processors and it is envisaged that the increased processing power provided by these advanced STBs may enable a wider range of applications to be implemented in the device of the invention and delays in providing images on the remote screen to be decreased. Desirably, the STB (or other gateway device) is provided with a second tuner which is separate from that which is used to select a channel for display on the TV display, the second tuner being controllable by the remote control device of the invention. STBs are known to be available which feature a second tuner for the purpose of recording a program other than the one being watched to a hard disk and it is expected that use could be made of this existing technology to enable many of the applications envisaged for the present invention. When a second tuner is present it is possible to access information (data or pictures) from any transport stream received by the TV receiver.

The device of the invention may be connected to the STB (or other gateway device) by a serial cable but is preferably connected by a wireless link, such as a Bluetooth link. This can be achieved by attaching Bluetooth ‘dongle’ modules to the serial ports of the gateway devide and the remote control device. It is envisaged that existing, installed STBs and other gateway devices may be upgraded in the field to provide functionality for the remote control device of the invention, by attaching such dongle modules and upgrading the flash memory of the gateway device with the relevant code. This provides a significant cost advantage to suppliers of gateway devices already in the field, who may provide a range of novel services to the consumer by means of a simple, low cost add-on to the existing generation of STBs and other gateway devices.

An example of a suitable software framework for the invention is shown in FIG. 2 below. The system requires a protocol for the transfer of commands and data between the remote control device and the gateway device (STB). The software stack used on the remote control device is based predominantly on freely available open source code. The software implements novel protocols to exchange information, interpret information and display the information using an appropriate GUI, for the device of the invention.

The system enables decoding of a second video stream in addition to a first that is decoded by the STB for display on the TV. The decoding of the second stream is conveniently carried out by means of suitably configured software on the main processor of a gateway device such as an STB. So as not to conflict with tasks already loaded on the processor and required by the STB or the cycle budget for these tasks (which can be unpredictable), the software decode desirably has a low processing load and is scalable so that it still works to satisfaction even at times when the available cycle budget of the STB processor is reduced.

In a preferred embodiment, both temporal (throwing away frames) and spatial (reducing the resolution) scalability are used. In one example, only I-frames are decoded and resolution is reduced eight times both horizontally and vertically. This can be implemented using the following method
i) A PES filter for the 2nd data stream is set up in the demux of the decoder
ii) Data is written into the PES buffer by the hardware demux
iii) If a full I-frame is found in the buffer, then decoding starts. (The decoding process is described in more detail below)
iv) The decoded image is then sent to the display (or GUI) of the remote control device. Before display, the image format of the I-frames may be mapped onto a palette
v) The PES filter is re-enabled and the cycle repeats.

In one embodiment, I-frames are decoded and only the DC components of the 8×8 blocks are calculated. This gives a reduction in resolution by ×8. With this reduced resolution it is possible still to detect changes in image content (for example, whether a commercial break has ended and a soccer match resumed). A significant amount of processing load may be saved by using only DC coefficients, since this eliminates the need for performing IDCT operations. All DCT coefficients 8×8 blocks, (so also DC's) are coded in the incoming MPEG2 bit stream as VLC words. The DC coefficient is located at the start of each macro block. However macro blocks are not byte aligned. This means that in order to get to the DC of the next macro block, all AC coefficients of the previous macro block must be skipped. This implies that basically a full variable length decode operation must be performed, just like for full resolution decoding. This is costly bit-wise processing and consumes by far the largest part of the processing load.

As only the length (rather than the exact value) of the AC coefficients are required, to skip AC coefficients, it is possible to process the VLC coefficients more efficiently by using characteristics of the MPEG VLC tables. For example, analysis of bits for a particular coefficient is ceased once the length of the coefficient is known, and the remaining bits can be skipped. The desired result of the decoding is to end up with a progressive picture. This means that for macro blocks or DCT blocks that are field coded, field to frame conversion must be performed. This is can be achieved simply by averaging the DC components of the fields.

The channel to be viewed in the display of the remote device may be changed without interference with the image on the main TV display. When requested by the user the remote control device sends a channel change command to the STB. The XML interpreter application handles this command by passing the channel number to the channel change function of the STB middleware. Many PDAs feature a built-in IR port which could also be used to control television functions such as volume, brightness etc if the correct remote control codes were known to the PDA.

Other potential applications of the device of the invention not described in detail here include: remote teletext display of information from channels other than that viewed on the TV display; localisation of advertising and content; interactive and ‘push’ advertising; remote monitoring of programs viewed on the main TV display; immersive applications for sports programs; consumer loyalty schemes; universal front end/remote control; new user interfaces; EPG search engines; instant messaging on the remote display; alternate views for gaming consoles.

The remote device 4 can receive information from a user via standard user interfaces such as keypad, touch screen including handwriting recognition and voice control.

It is to be understood that the foregoing is merely exemplary of some embodiments and applications of the invention and is not intended to be limiting on the scope of the invention as defined in the appended claims.

1. A remote control device for use with a television receiving apparatus, the television receiving apparatus comprising; a system controller, a receiver for receiving broadcast video data and supplemental textual data and a TV display for displaying the data, the remote control device being operable to communicate with the system controller of the television receiving apparatus and having it's own display and user-operable control, wherein, the remote control device comprises means responsive to the user operable control for requesting and downloading video and/or supplemental textual data received by the television receiving apparatus and not currently displayed on the TV display, to be viewed by the user on the display of the remote control device.

2. A remote control device as claimed in claim 1 wherein the system controller of the television receiving apparatus comprises two or more tuners one of which is controllable by means of the user-operable control to find data and information for display on the display of the remote control device.

3. A remote control device as claimed in claim 1 or claim 2 wherein the user operable control comprises a user interface which includes an alphanumeric keyboard

4. A remote control device as claimed in claim 3 wherein the keyboard is a virtual keyboard displayed in the display of the remote control device and the display incorporates touch screen technology.

5. A remote control device as claimed in any of claims 1 to 3 wherein the user operable control comprises a user interface which includes touch screen technology incorporated into the display of the device.

6. A remote control device as claimed in any preceding claim wherein the user operable control comprises a user interface which includes speech recognition.

7. A remote control device as claimed in any preceding claim wherein the remote control device is operable to communicate with the system controller by cordless means.

8. A remote control device as claimed in claim 7 wherein the cordless means are infra red.

9. A remote control device as claimed in claim 7 wherein the cordless means are Bluetooth, IEEE 802.11 or HomeRF.

10. A remote control device as claimed in any preceding claim further comprising a memory for storing data and information received by the device.

11. A remote control device as claimed in any preceding claim wherein the remote control is provided with means responsive to the user operable control for requesting, receiving and displaying data or information from an alternative audio visual device other than is currently being displayed on the TV display.

12. A remote control device as claimed in claim 11 wherein the alternative audio-visual device is selected from a VCR, a video camera, a DVD player and a games console.

13. A television receiving apparatus comprising a receiver for receiving broadcast video data and supplemental textual data in a plurality of data streams, a TV display for displaying data and a system controller, the system controller having means for receiving and processing a request from an alternative display device to display data associated with a data stream other than that (or those) displayed on the TV display on the alternative display device.

14. A television receiving apparatus comprising a receiver for receiving broadcast video data and supplemental textual data, a TV display for displaying the data and a system controller, the system controller comprising a plurality of tuners at least one tuner being controllable by means of the user-operable control associated with a remote control device as claimed in any preceding claim to display data on the display of the remote control device.

15. A method for providing interactive participation in a TV programme comprising;
in a first data stream, broadcasting video of the programme to be displayed on a first display apparatus associated with a television receiving apparatus;
in a second data stream providing information relating to the content of the first data stream to be displayed on a second display apparatus, which second display apparatus is provided with a user interface; and
requesting a user response to the information contained in the second data stream.

16. A method as claimed in claim 15 further comprising;
receiving a user response and updating and re-transmitting the information in the second data stream based on the nature of the user response.

17. A method as claimed in claim 15 or 16 wherein the first display apparatus is a TV display and the second display apparatus is a display provided on a remote control device.

18. A method as claimed in any of claims 15 to 17 wherein the second data stream comprises questions about the content of the programme being broadcast via the first data stream.

19. A method as claimed in claim 18 wherein the requested user response is an answer to the questions in the second data stream.

20. A method as claimed in any of claims 15 to 19 wherein the second data stream comprises electronic credits for use by the recipient.

21. A method as claimed in any of claims 18 to 20 wherein the questions are presented with associated odds and the user response includes an acceptance of the odds and authorisation to debit a defined number of credits electronically from an account held by the user.

22. A method as claimed in claim 21 wherein the updated second data stream responsive to the user response includes credits amounting to a value based on a value of credits authorised for debit in the user response, the odds presented with the questions and the correctness of the user response.

23. A method as claimed in claim 21 or 22 wherein the first data stream comprises video of a real time, live action event and the questions relate to actions anticipated but not yet carried out in the live action event.

24. A method as claimed in claim 23 wherein the live action event is a sporting event.

25. A method as claimed in any of claims 21 to 24 wherein the credits correspond to actual currency in a users personal account.

26. A method as claimed in any of claims 21 to 24 wherein the credits correspond to electronic credits of virtual currency originated by the broadcaster of the programme and provided to the user through previous interactions.

27. A method as claimed in any of claims 15 to 17 wherein the information in the second data stream comprises an invitation to purchase goods or services and the user response comprises an acceptance of the invitation and authorisation to debit a defined number of credits electronically from an account held by the user.

28. A method as claimed in any of claims 15 to 27 further comprising recording the user response whereby to build up a profile of the user, and selectively targeting the user with information which the profile suggests is of particular interest to the user.

29. A method as claimed in claims 15 to 17 wherein the first data stream comprises video of a real time, live action event; the second data stream includes options for perspectives from which the event may be viewed by the user, and the updated second data stream comprises a view of the event from the perspective selected by the user in his response.

30. A method as claimed in claim 29 wherein the first data stream is also updated in response to the user response thereby to provide the selected perspective view of the live action broadcast on the first display apparatus.

31. A method for displaying images and/or information associated with a data stream received by a television receiving apparatus on a display device remote from the television receiving apparatus comprising;
in response to a request, locating a data stream having associated therewith the requested images and/or information;
extracting the located data stream;
defining the extracted data stream in a form mutually comprehensible to the television receiving apparatus and the remote display device;
transmitting the defined data stream to the remote display device; and
rendering the images and/or information associated with the defined data stream on a display screen of remote display device.

32. A method as claimed in claim 31 wherein the step of extracting involves instructing a tuner in the TV receiving apparatus to change to a specified frequency.

33. A method as claimed in claim 31 or 32 wherein the step of defining involves the use of XML.

34. A method as claimed in any of claims 30 to 33 wherein the step of transmitting involves the use of a wireless protocol.

35. A method as claimed in claim 34 wherein the wireless protocol is a Bluetooth protocol.
